(19) United States
(12) Patent Application Publication
(10) Pub. No.: US 2026/0333335 A1
(43) Pub. Date: Oct. 22, 2026

(54) METHOD AND DEVICE FOR BEAM MANAGEMENT ACCORDING TO RA MODE IN SIDELINK COMMUNICATION

(71) Applicants: HYUNDAI MOTOR COMPANY, Seoul (KR); Kia Corporation, Seoul (KR); GACHON UNIVERSITY INDUSTRY-ACADEMIC COOPERATION FOUNDATION, Seongnam-si, Gyeonggi-do (KR)

(72) Inventors: Ui Hyun HONG, Hwaseong-si, Gyeonggi-do (KR); Hyuk Min SON, Seoul (KR)

(73) Assignees: HYUNDAI MOTOR COMPANY, Seoul (KR); Kia Corporation, Seoul (KR); GACHON UNIVERSITY INDUSTRY-ACADEMIC COOPERATION FOUNDATION, Seongnam-si, Gyeonggi-do (KR)

(21) Appl. No.: 19/115,092

(22) PCT Filed: Oct. 26, 2023
(86) PCT No.: PCT/KR2023/016724

§ 371 Date: Mar. 25, 2025

(30) Foreign Application Priority Data
Oct. 28, 2022 (KR) 10-2022-0141704

(51) Int. Cl. H04W 72/044; H04W 72/25

(52) U.S. Cl. CPC H04W 72/046; H04W 72/25

(57) ABSTRACT

A method and a device for beam management according to an RA mode in sidelink communication are disclosed. A method for a first UE comprises the steps of: transmitting, to a base station, an SR-BM requesting resource allocation for a BM operation; receiving, from the base station, a response-SR comprising resource allocation information in response to the SR-BM; and performing the BM operation with a second UE on the basis of resources indicated by the resource allocation information.

### TECHNICAL FIELD

The present disclosure relates to a sidelink communication technique, and more particularly, to a technique for beam management according to a resource allocation (RA) mode.

### BACKGROUND ART

A communication network (e.g., 5G communication network or 6G communication network) is being developed to provide enhanced communication services compared to the existing communication networks (e.g., long term evolution (LTE), LTE-Advanced (LTE-A), etc.). The 5G communication network (e.g., New Radio (NR) communication network) can support frequency bands both below 6 GHz and above 6 GHz. In other words, the 5G communication network can support both a frequency region 1 (FR1) and/or FR2 bands. Compared to the LTE communication network, the 5G communication network can support various communication services and scenarios. For example, usage scenarios of the 5G communication network may include enhanced Mobile BroadBand (eMBB), Ultra Reliable Low Latency Communication (URLLC), massive Machine Type Communication (mMTC), and the like.

The 6G communication network can support a variety of communication services and scenarios compared to the 5G communication network. The 6G communication network can meet the requirements of hyper-performance, hyper-bandwidth, hyper-space, hyper-precision, hyper-intelligence, and/or hyper-reliability. The 6G communication network can support diverse and wide frequency bands and can be applied to various usage scenarios such as terrestrial communication, non-terrestrial communication, sidelink communication, and the like.

Meanwhile, sidelink communication between terminals may be performed based on a beamforming scheme, and a beam management operation for sidelink communication may be required. The sidelink communication may be performed based on a resource allocation (RA) mode 1 or RA mode 2. In the RA mode 1, specific procedures for the beam management operation may be required, and in the RA Mode 2, specific procedures for the beam management operation may be required.

### DISCLOSURE

### Technical Problem

The present disclosure is directed to providing a method and an apparatus for beam management according to an RA mode in sidelink communication.

### Technical Solution

A method of a first user equipment (UE), according to exemplary embodiments of the present disclosure for achieving the above-described objective, may comprise: transmitting a scheduling request (SR)-beam management (BM) requesting resource allocation for a BM operation to a base station; in response to the SR-BM, receiving a response-SR including resource allocation information from the base station; and performing the BM operation with a second UE based on resources indicated by the resource allocation information.

The performing of the BM operation may comprise: transmitting a beam state information (BSI) request to the second UE based on the resources indicated by the resource allocation information; transmitting a BM-reference signal (RS) to the second UE based on the resources indicated by the resource allocation information; receiving a BSI report including beam measurement information based on the BM-RS from the second UE; and managing a transmission beam of the first UE based on the beam measurement information included in the BSI report, wherein the BSI request may trigger transmission of the BSI report.

The BSI request may be included in sidelink control information (SCI) transmitted by the first UE to the second UE, and the BM-RS may be transmitted on a physical sidelink shared channel (PSSCH) scheduled by the SCI.

A BM-resource pool (RP) for the BM operation may be configured independently from a sidelink-resource pool (SL-RP) for SL communication between the first UE and the second UE, and at least one of the BSI request, the BM-RS, or the BSI report may be transmitted and received within the BM-RP.

A pair of the BM-RP and the SL-RP may be configured to the first UE, and at least one of a transmission beam of the first UE or a reception beam of the second UE determined by the BM operation within the BM-RP may be used for the SL communication between the first UE and the second UE within the SL-RP paired with the BM-RP.

The resource allocation information of the response-SR may include information on resources for the SL-RP and information on resources for the BM-RP.

The BSI request may include transmission scheme information of the BM-RS, and the transmission scheme information may indicate a scheme in which the first UE transmits the BM-RS using a same transmission beam or a scheme in which the first UE transmits the BM-RS based on a beam sweeping manner.

The BSI request may include resource information for transmission of the BSI report, and the BSI report may be received in resources indicated by the resource information included in the BSI request.

The method may further comprise: receiving a BM request from the second UE indicating that the BM operation is required, wherein a transmission operation of the SR-BM may be triggered based on the BM request.

The SR-BM may be transmitted when the BM operation is required, and cases when the BM operation is required may include at least one of a case when a transmission beam of the first UE needs to be change, a case when a reception beam of the second UE needs to be changed, a case when a beam pair between the first UE and the second UE needs to be changed, or a case when a beam failure occurs between the first UE and the second UE.

A method of a second user equipment (UE), according to exemplary embodiments of the present disclosure for achieving the above-described objective, may comprise: receiving, from a first UE, sidelink control information (SCI) including a beam state information (BSI) request; receiving, from the first UE, a beam management-reference signal (BM-RS) on a physical sidelink shared channel (PSSCH) scheduled by the SCI; generating BSI by performing a beam measurement operation based on the BM-RS; transmitting a BSI report including the BSI to the first UE; and managing a reception beam of the second UE based on the BSI.

The BSI request may trigger transmission of the BSI report, the BSI request may include resource information for transmission of the BSI report, and the BSI report may be transmitted in resources indicated by the resource information included in the BSI request.

A BM-resource pool (RP) for a BM operation may be configured independently from a sidelink-resource pool (SL-RP) for SL communication between the first UE and the second UE, and at least one of the BSI request, the BM-RS, or the BSI report may be transmitted and received within the BM-RP.

A pair of the BM-RP and the SL-RP may be configured to the second UE, and at least one of a transmission beam of the first UE or a reception beam of the second UE determined by the BM operation within the BM-RP may be used for the SL communication between the first UE and the second UE within the SL-RP paired with the BM-RP.

The BSI request may include transmission scheme information of the BM-RS, and the transmission scheme information may indicate a scheme in which the first UE transmits the BM-RS using a same transmission beam or a scheme in which the first UE transmits the BM-RS based on a beam sweeping manner.

The method may further comprise: transmitting a BM request to the first UE indicating that a BM operation is required, wherein the BM operation may be triggered based on the BM request.

The BM request may be transmitted when the BM operation is required, and cases when the BM operation is required may include at least one of a case when a transmission beam of the first UE needs to be change, a case when a reception beam of the second UE needs to be changed, a case when a beam pair between the first UE and the second UE needs to be changed, or a case when a beam failure occurs between the first UE and the second UE.

A first user equipment (UE), according to exemplary embodiments of the present disclosure for achieving the above-described objective, may comprise at least one processor, and the at least one processor may cause the first UE to perform: transmitting a scheduling request (SR)-beam management (BM) requesting resource allocation for a BM operation to a base station; in response to the SR-BM, receiving a response-SR including resource allocation information from the base station; and performing the BM operation with a second UE based on resources indicated by the resource allocation information.

In the performing of the BM operation, the at least one processor may further cause the first UE to perform: transmitting a beam state information (BSI) request to the second UE based on the resources indicated by the resource allocation information; transmitting a BM-reference signal (RS) to the second UE based on the resources indicated by the resource allocation information; receiving a BSI report including beam measurement information based on the BM-RS from the second UE; and managing a transmission beam of the first UE based on the beam measurement information included in the BSI report, wherein the BSI request may trigger transmission of the BSI report.

The at least one processor may further cause the first UE to perform: receiving a BM request from the second UE indicating that the BM operation is required, wherein a transmission operation of the SR-BM may be triggered based on the BM request.

### Advantageous Effects

According to the present disclosure, a transmitting terminal may request resource allocation for a beam management (BM) operation from a base station and may receive resource allocation information from the base station. The transmitting terminal may perform the BM operation with the receiving terminal based on resources indicated by the resource allocation information. Through the BM operation, a beam pair between a transmission beam of the transmitting terminal and a reception beam of the receiving terminal can be configured. Accordingly, sidelink communication between the transmitting terminal and the receiving terminal can be performed efficiently, and the performance of the communication system can be improved.

### DESCRIPTION OF DRAWINGS

FIG. 1 is a conceptual diagram illustrating scenarios of Vehicle-to-Everything (V2X) communications.

FIG. 2 is a conceptual diagram illustrating a first exemplary embodiment of a communication system.

FIG. 3 is a conceptual diagram illustrating a first exemplary embodiment of a communication node constituting a communication system.

FIG. 4 is a block diagram illustrating a first exemplary embodiment of communication nodes performing communication.

FIG. 5A is a block diagram illustrating a first exemplary embodiment of a transmission path.

FIG. 5B is a block diagram illustrating a first exemplary embodiment of a reception path.

FIG. 6 is a block diagram illustrating a first exemplary embodiment of a user plane protocol stack of a UE performing sidelink communication.

FIG. 7 is a block diagram illustrating a first exemplary embodiment of a control plane protocol stack of a UE performing sidelink communication.

FIG. 8 is a block diagram illustrating a second exemplary embodiment of a control plane protocol stack of a UE performing sidelink communication.

FIG. 9 is a sequence chart illustrating a first exemplary embodiment of BM operations.

FIG. 10 is a conceptual diagram illustrating a first exemplary embodiment of a BM-RS transmission method.

FIG. 11 is a sequence chart illustrating a second exemplary embodiment of BM operations.

### MODE FOR INVENTION

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

In the present disclosure, ‘(re)transmission’ may refer to ‘transmission’, ‘retransmission’, or ‘transmission and retransmission’, ‘(re)configuration’ may refer to ‘configuration’, ‘reconfiguration’, or ‘configuration and reconfiguration’, ‘(re)connection’ may refer to ‘connection’, ‘reconnection’, or ‘connection and reconnection’, and ‘(re)access’ may refer to ‘access’, ‘re-access’, or ‘access and re-access’.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, exemplary embodiments of the present disclosure will be described in detail with reference to the accompanying drawings. In describing the disclosure, to facilitate the entire understanding of the disclosure, like numbers refer to like elements throughout the description of the figures and the repetitive description thereof will be omitted. The operations according to the exemplary embodiments described explicitly in the present disclosure, as well as combinations of the exemplary embodiments, extensions of the exemplary embodiments, and/or variations of the exemplary embodiments, may be performed. Some operations may be omitted, and a sequence of operations may be altered.

Even when a method (e.g., transmission or reception of a signal) to be performed at a first communication node among communication nodes is described in exemplary embodiments, a corresponding second communication node may perform a method (e.g., reception or transmission of the signal) corresponding to the method performed at the first communication node. That is, when an operation of a user equipment (UE) is described, a base station corresponding thereto may perform an operation corresponding to the operation of the UE. Conversely, when an operation of a base station is described, a corresponding UE may perform an operation corresponding to the operation of the base station.

The base station may be referred to by various terms such as NodeB, evolved NodeB, next generation node B (gNodeB), gNB, device, apparatus, node, communication node, base transceiver station (BTS), radio remote head (RRH), transmission reception point (TRP), radio unit (RU), road side unit (RSU), radio transceiver, access point, access node, and the like. The user equipment (UE) may be referred to by various terms such as terminal, device, apparatus, node, communication node, end node, access terminal, mobile terminal, station, subscriber station, mobile station, portable subscriber station, on-board unit (OBU), and the like.

In the present disclosure, signaling may be one or a combination of two or more of higher layer signaling, MAC signaling, and physical (PHY) signaling. A message used for higher layer signaling may be referred to as a ‘higher layer message’ or ‘higher layer signaling message’. A message used for MAC signaling may be referred to as a ‘MAC message’ or ‘MAC signaling message’. A message used for PHY signaling may be referred to as a ‘PHY message’ or ‘PHY signaling message’. The higher layer signaling may refer to an operation of transmitting and receiving system information (e.g., master information block (MIB), system information block (SIB)) and/or an RRC message. The MAC signaling may refer to an operation of transmitting and receiving a MAC control element (CE). The PHY signaling may refer to an operation of transmitting and receiving control information (e.g., downlink control information (DCI), uplink control information (UCI), or sidelink control information (SCI)).

In the present disclosure, ‘configuration of an operation (e.g., transmission operation)’ may refer to signaling of configuration information (e.g., information elements, parameters) required for the operation and/or information indicating to perform the operation. ‘configuration of information elements (e.g., parameters)’ may refer to signaling of the information elements. In the present disclosure, ‘signal and/or channel’ may refer to signal, channel, or both signal and channel, and ‘signal’ may be used to mean ‘signal and/or channel’. In the present disclosure, information may be used in the sense of information element(s), field(s), field value(s), field information, and/or parameter(s).

A communication network to which exemplary embodiments are applied is not limited to that described below, and the exemplary embodiments may be applied to various communication networks (e.g., 4G communication networks, 5G communication networks, and/or 6G communication networks). Here, ‘communication network’ may be used interchangeably with a term ‘communication system’.

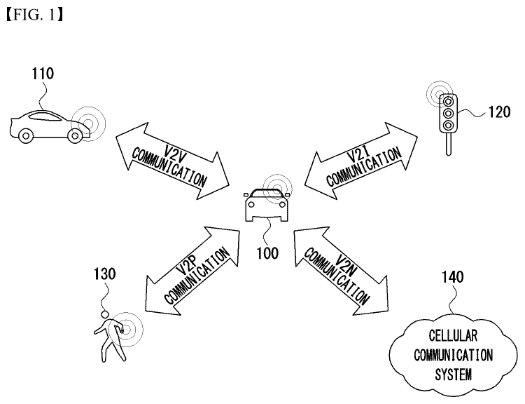

FIG. 1 is a conceptual diagram illustrating scenarios of Vehicle-to-Everything (V2X) communications.

As shown in FIG. 1, V2X communications may include Vehicle-to-Vehicle (V2V) communications, Vehicle-to-Infrastructure (V2I) communications, Vehicle-to-Pedestrian (V2P) communications, Vehicle-to-Network (V2N) communications, and the like. The V2X communications may be supported by a communication system (e.g., communication network) 140, and the V2X communications supported by the communication system 140 may be referred to as ‘Cellular-V2X (C-V2X) communications’. Here, the communication system 140 may include the 4G communication system (e.g., LTE communication system or LTE-A communication system), 5G communication system (e.g., NR communication system), and the like.

The V2V communications may include communications between a first vehicle 100 (e.g., a communication node located in the vehicle 100) and a second vehicle 110 (e.g., a communication node located in the vehicle 110). Various driving information such as velocity, heading, time, position, and the like may be exchanged between the vehicles 100 and 110 through the V2V communications. For example, autonomous driving (e.g., platooning) may be supported based on the driving information exchanged through the V2V communications. The V2V communications supported by the communication system 140 may be performed based on sidelink communication technologies (e.g., Proximity Based Services (ProSe) and Device-to-Device (D2D) communication technologies, and the like). In this case, the communications between the vehicles 100 and 110 may be performed using at least one sidelink channel.

The V2I communications may include communications between the first vehicle 100 and an infrastructure (e.g., road side unit (RSU)) 120 located on a roadside. The infrastructure 120 may include a traffic light or a street light which is located on the roadside. For example, when the V2I communications are performed, the communications may be performed between the communication node located in the first vehicle 100 and a communication node located in a traffic light. Traffic information, driving information, and the like may be exchanged between the first vehicle 100 and the infrastructure 120 through the V2I communications. The V2I communications supported by the communication system 140 may be performed based on sidelink communication technologies (e.g., ProSe and D2D communication technologies, and the like). In this case, the communications between the vehicle 100 and the infrastructure 120 may be performed using at least one sidelink channel.

The V2P communications may include communications between the first vehicle 100 (e.g., the communication node located in the vehicle 100) and a person 130 (e.g., a communication node carried by the person 130). The driving information of the first vehicle 100 and movement information of the person 130 such as velocity, heading, time, position, and the like may be exchanged between the vehicle 100 and the person 130 through the V2P communications. The communication node located in the vehicle 100 or the communication node carried by the person 130 may generate an alarm indicating a danger by judging a dangerous situation based on the obtained driving information and movement information. The V2P communications supported by the communication system 140 may be performed based on sidelink communication technologies (e.g., ProSe and D2D communication technologies, and the like). In this case, the communications between the communication node located in the vehicle 100 and the communication node carried by the person 130 may be performed using at least one sidelink channel.

The V2N communications may be communications between the first vehicle 100 (e.g., the communication node located in the vehicle 100) and the communication system (e.g., communication network) 140. The V2N communications may be performed based on the 4G communication technology (e.g., LTE or LTE-A specified as the 3GPP standards) or the 5G communication technology (e.g., NR specified as the 3GPP standards). Also, the V2N communications may be performed based on a Wireless Access in Vehicular Environments (WAVE) communication technology or a Wireless Local Area Network (WLAN) communication technology which is defined in Institute of Electrical and Electronics Engineers (IEEE) 802.11, a Wireless Personal Area Network (WPAN) communication technology defined in IEEE 802.15, or the like.

Meanwhile, the communication system 140 supporting the V2X communications may be configured as follows.

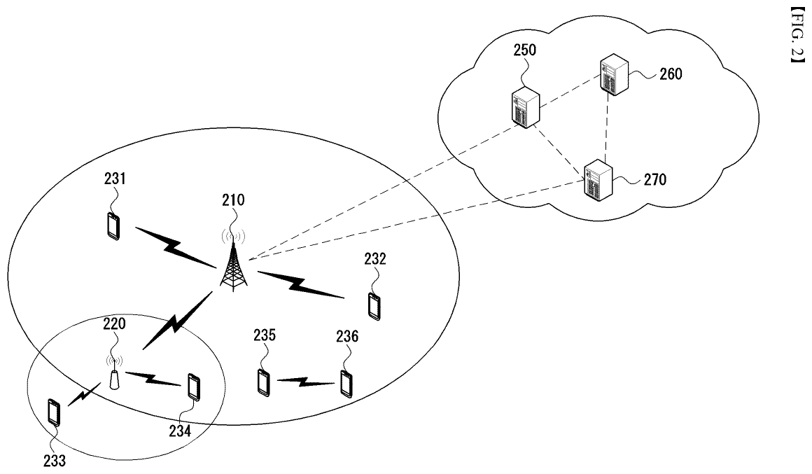

FIG. 2 is a conceptual diagram illustrating a first exemplary embodiment of a communication system.

As shown in FIG. 2, a communication system may include an access network, a core network, and the like. The access network may include a base station 210, a relay 220, user equipment (UEs) 231 through 236, and the like. The UEs 231 through 236 may include communication nodes located in the vehicles 100 and 110 of FIG. 1, the communication node located in the infrastructure 120 of FIG. 1, the communication node carried by the person 130 of FIG. 1, and the like. When the communication system supports the 4G communication technology, the core network may include a serving gateway (S-GW) 250, a packet data network (PDN) gateway (P-GW) 260, a mobility management entity (MME) 270, and the like.

When the communication system supports the 5G communication technology, the core network may include a user plane function (UPF) 250, a session management function (SMF) 260, an access and mobility management function (AMF) 270, and the like. Alternatively, when the communication system operates in a Non-Stand Alone (NSA) mode, the core network constituted by the S-GW 250, the P-GW 260, and the MME 270 may support the 5G communication technology as well as the 4G communication technology, and the core network constituted by the UPF 250, the SMF 260, and the AMF 270 may support the 4G communication technology as well as the 5G communication technology.

In addition, when the communication system supports a network slicing technique, the core network may be divided into a plurality of logical network slices. For example, a network slice supporting V2X communications (e.g., a V2V network slice, a V2I network slice, a V2P network slice, a V2N network slice, etc.) may be configured, and the V2X communications may be supported through the V2X network slices configured in the core network.

The communication nodes (e.g., base station, relay, UE, S-GW, P-GW, MME, UPF, SMF, AMF, etc.) constituting the communication system may perform communications by using at least one communication technology among a code division multiple access (CDMA) technology, a time division multiple access (TDMA) technology, a frequency division multiple access (FDMA) technology, an orthogonal frequency division multiplexing (OFDM) technology, a filtered OFDM technology, an orthogonal frequency division multiple access (OFDMA) technology, a single carrier FDMA (SC-FDMA) technology, a non-orthogonal multiple access (NOMA) technology, a generalized frequency division multiplexing (GFDM) technology, a filter bank multi-carrier (FBMC) technology, a universal filtered multi-carrier (UFMC) technology, and a space division multiple access (SDMA) technology.

The communication nodes (e.g., base station, relay, UE, S-GW, P-GW, MME, UPF, SMF, AMF, etc.) constituting the communication system may be configured as follows.

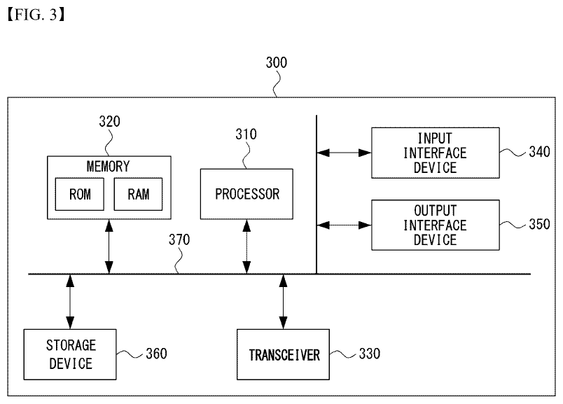

FIG. 3 is a conceptual diagram illustrating a first exemplary embodiment of a communication node constituting a communication system.

As shown in FIG. 3, a communication node 300 may comprise at least one processor 310, a memory 320, and a transceiver 330 connected to a network for performing communications. Also, the communication node 300 may further comprise an input interface device 340, an output interface device 350, a storage device 360, and the like. Each component included in the communication node 300 may communicate with each other as connected through a bus 370.

However, each of the components included in the communication node 300 may be connected to the processor 310 via a separate interface or a separate bus rather than the common bus 370. For example, the processor 310 may be connected to at least one of the memory 320, the transceiver 330, the input interface device 340, the output interface device 350, and the storage device 360 via a dedicated interface.

The processor 310 may execute at least one program command stored in at least one of the memory 320 and the storage device 360. The processor 310 may refer to a central processing unit (CPU), a graphics processing unit (GPU), or a dedicated processor on which methods in accordance with exemplary embodiments of the present disclosure are performed. Each of the memory 320 and the storage device 360 may include at least one of a volatile storage medium and a non-volatile storage medium. For example, the memory 320 may comprise at least one of read-only memory (ROM) and random access memory (RAM).

Referring again to FIG. 2, in the communication system, the base station 210 may form a macro cell or a small cell, and may be connected to the core network via an ideal backhaul or a non-ideal backhaul. The base station 210 may transmit signals received from the core network to the UEs 231 through 236 and the relay 220, and may transmit signals received from the UEs 231 through 236 and the relay 220 to the core network. The UEs 231, 232, 234, 235 and 236 may belong to a cell coverage of the base station 210. The UEs 231, 232, 234, 235 and 236 may be connected to the base station 210 by performing a connection establishment procedure with the base station 210. The UEs 231, 232, 234, 235 and 236 may communicate with the base station 210 after being connected to the base station 210.

The relay 220 may be connected to the base station 210 and may relay communications between the base station 210 and the UEs 233 and 234. That is, the relay 220 may transmit signals received from the base station 210 to the UEs 233 and 234, and may transmit signals received from the UEs 233 and 234 to the base station 210. The UE 234 may belong to both of the cell coverage of the base station 210 and the cell coverage of the relay 220, and the UE 233 may belong to the cell coverage of the relay 220. That is, the UE 233 may be located outside the cell coverage of the base station 210. The UEs 233 and 234 may be connected to the relay 220 by performing a connection establishment procedure with the relay 220. The UEs 233 and 234 may communicate with the relay 220 after being connected to the relay 220.

The base station 210 and the relay 220 may support multiple-input multiple-output (MIMO) technologies (e.g., single user (SU)-MIMO, multi-user (MU)-MIMO, massive MIMO, etc.), coordinated multipoint (COMP) communication technologies, carrier aggregation (CA) communication technologies, unlicensed band communication technologies (e.g., Licensed Assisted Access (LAA), enhanced LAA (eLAA), etc.), sidelink communication technologies (e.g., ProSe communication technology, D2D communication technology), or the like. The UEs 231, 232, 235 and 236 may perform operations corresponding to the base station 210 and operations supported by the base station 210. The UEs 233 and 234 may perform operations corresponding to the relays 220 and operations supported by the relays 220.

Here, the base station 210 may be referred to as a Node B (NB), evolved Node B (eNB), base transceiver station (BTS), radio remote head (RRH), transmission reception point (TRP), radio unit (RU), roadside unit (RSU), radio transceiver, access point, access node, or the like. The relay 220 may be referred to as a small base station, relay node, or the like. Each of the UEs 231 through 236 may be referred to as a terminal, access terminal, mobile terminal, station, subscriber station, mobile station, portable subscriber station, node, device, on-broad unit (OBU), or the like.

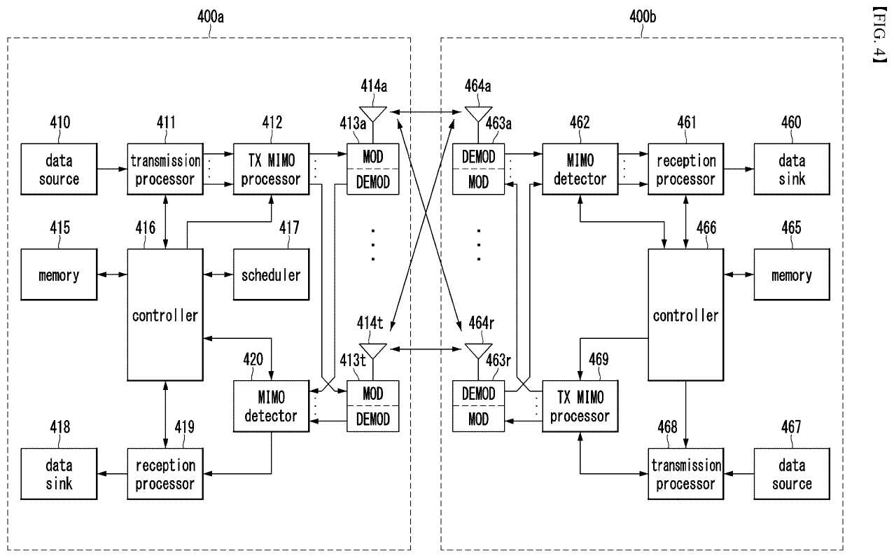

Meanwhile, communication nodes that perform communications in the communication network may be configured as follows. A communication node shown in FIG. 4 may be a specific exemplary embodiment of the communication node shown in FIG. 3.

FIG. 4 is a block diagram illustrating a first exemplary embodiment of communication nodes performing communication.

As shown in FIG. 4, each of a first communication node 400a and a second communication node 400b may be a base station or UE. The first communication node 400a may transmit a signal to the second communication node 400b. A transmission processor 411 included in the first communication node 400a may receive data (e.g., data unit) from a data source 410. The transmission processor 411 may receive control information from a controller 416. The control information may include at least one of system information, RRC configuration information (e.g., information configured by RRC signaling), MAC control information (e.g., MAC CE), or PHY control information (e.g., DCI, SCI).

The transmission processor 411 may generate data symbol(s) by performing processing operations (e.g., encoding operation, symbol mapping operation, etc.) on the data. The transmission processor 411 may generate control symbol(s) by performing processing operations (e.g., encoding operation, symbol mapping operation, etc.) on the control information. In addition, the transmission processor 411 may generate synchronization/reference symbol(s) for synchronization signals and/or reference signals.

A Tx MIMO processor 412 may perform spatial processing operations (e.g., precoding operations) on the data symbol(s), control symbol(s), and/or synchronization/reference symbol(s). An output (e.g., symbol stream) of the Tx MIMO processor 412 may be provided to modulators (MODs) included in transceivers 413a to 413t. The modulator may generate modulation symbols by performing processing operations on the symbol stream, and may generate signals by performing additional processing operations (e.g., analog conversion operations, amplification operation, filtering operation, up-conversion operation, etc.) on the modulation symbols. The signals generated by the modulators of the transceivers 413a to 413t may be transmitted through antennas 414a to 414t.

The signals transmitted by the first communication node 400a may be received at antennas 464a to 464r of the second communication node 400b. The signals received at the antennas 464a to 464r may be provided to demodulators (DEMODs) included in transceivers 463a to 463r. The demodulator (DEMOD) may obtain samples by performing processing operations (e.g., filtering operation, amplification operation, down-conversion operation, digital conversion operation, etc.) on the signals. The demodulator may perform additional processing operations on the samples to obtain symbols. A MIMO detector 462 may perform MIMO detection operations on the symbols. A reception processor 461 may perform processing operations (e.g., de-interleaving operation, decoding operation, etc.) on the symbols. An output of the reception processor 461 may be provided to a data sink 460 and a controller 466. For example, the data may be provided to the data sink 460 and the control information may be provided to the controller 466.

On the other hand, the second communication node 400b may transmit signals to the first communication node 400a. A transmission processor 469 included in the second communication node 400b may receive data (e.g., data unit) from a data source 467 and perform processing operations on the data to generate data symbol(s). The transmission processor 468 may receive control information from the controller 466 and perform processing operations on the control information to generate control symbol(s). In addition, the transmission processor 468 may generate reference symbol(s) by performing processing operations on reference signals.

A Tx MIMO processor 469 may perform spatial processing operations (e.g., precoding operations) on the data symbol(s), control symbol(s), and/or reference symbol(s). An output (e.g., symbol stream) of the Tx MIMO processor 469 may be provided to modulators (MODs) included in the transceivers 463a to 463t. The modulator may generate modulation symbols by performing processing operations on the symbol stream, and may generate signals by performing additional processing operations (e.g., analog conversion operation, amplification operation, filtering operation, up-conversion operations) on the modulation symbols. The signals generated by the modulators of the transceivers 463a to 463t may be transmitted through the antennas 464a to 464t.

The signals transmitted by the second communication node 400b may be received at the antennas 414a to 414r of the first communication node 400a. The signals received at the antennas 414a to 414r may be provided to demodulators (DEMODs) included in the transceivers 413a to 413r. The demodulator may obtain samples by performing processing operations (e.g., filtering operation, amplification operation, down-conversion operation, digital conversion operation) on the signals. The demodulator may perform additional processing operations on the samples to obtain symbols. A MIMO detector 420 may perform a MIMO detection operation on the symbols. The reception processor 419 may perform processing operations (e.g., de-interleaving operation, decoding operation, etc.) on the symbols. An output of the reception processor 419 may be provided to a data sink 418 and the controller 416. For example, the data may be provided to the data sink 418 and the control information may be provided to the controller 416.

Memories 415 and 465 may store the data, control information, and/or program codes. A scheduler 417 may perform scheduling operations for communication. The processors 411, 412, 419, 461, 468, and 469 and the controllers 416 and 466 shown in FIG. 4 may be the processor 310 shown in FIG. 3, and may be used to perform methods described in the present disclosure.

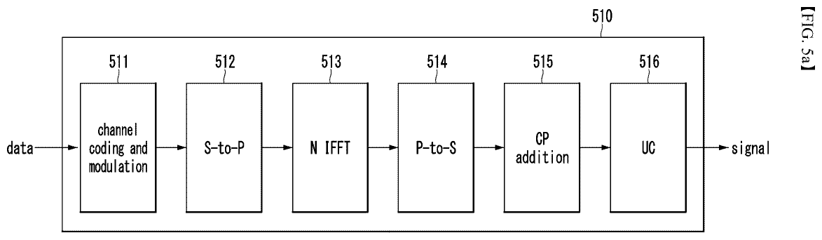

FIG. 5A is a block diagram illustrating a first exemplary embodiment of a transmission path, and FIG. 5B is a block diagram illustrating a first exemplary embodiment of a reception path.

As shown in FIGS. 5A and 5B, a transmission path 510 may be implemented in a communication node that transmits signals, and a reception path 520 may be implemented in a communication node that receives signals. The transmission path 510 may include a channel coding and modulation block 511, a serial-to-parallel (S-to-P) block 512, an N-point inverse fast Fourier transform (N-point IFFT) block 513, a parallel-to-serial (P-to-S) block 514, a cyclic prefix (CP) addition block 515, and up-converter (UC) 516. The reception path 520 may include a down-converter (DC) 521, a CP removal block 522, an S-to-P block 523, an N-point FFT block 524, a P-to-S block 525, and a channel decoding and demodulation block 526. Here, N may be a natural number.

In the transmission path 510, information bits may be input to the channel coding and modulation block 511. The channel coding and modulation block 511 may perform a coding operation (e.g., low-density parity check (LDPC) coding operation, polar coding operation, etc.) and a modulation operation (e.g., Quadrature Phase Shift Keying (OPSK), Quadrature Amplitude Modulation (QAM), etc.) on the information bits. An output of the channel coding and modulation block 511 may be a sequence of modulation symbols.

The S-to-P block 512 may convert frequency domain modulation symbols into parallel symbol streams to generate N parallel symbol streams. N may be the IFFT size or the FFT size. The N-point IFFT block 513 may generate time domain signals by performing an IFFT operation on the N parallel symbol streams. The P-to-S block 514 may convert the output (e.g., parallel signals) of the N-point IFFT block 513 to serial signals to generate the serial signals.

The CP addition block 515 may insert a CP into the signals. The UC 516 may up-convert a frequency of the output of the CP addition block 515 to a radio frequency (RF) frequency. Further, the output of the CP addition block 515 may be filtered in baseband before the up-conversion.

The signal transmitted from the transmission path 510 may be input to the reception path 520. Operations in the reception path 520 may be reverse operations for the operations in the transmission path 510. The DC 521 may down-convert a frequency of the received signals to a baseband frequency. The CP removal block 522 may remove a CP from the signals. The output of the CP removal block 522 may be serial signals. The S-to-P block 523 may convert the serial signals into parallel signals. The N-point FFT block 524 may generate N parallel signals by performing an FFT algorithm. The P-to-S block 525 may convert the parallel signals into a sequence of modulation symbols. The channel decoding and demodulation block 526 may perform a demodulation operation on the modulation symbols and may restore data by performing a decoding operation on a result of the demodulation operation.

In FIGS. 5A and 5B, discrete Fourier transform (DFT) and inverse DFT (IDFT) may be used instead of FFT and IFFT. Each of the blocks (e.g., components) in FIGS. 5A and 5B may be implemented by at least one of hardware, software, or firmware. For example, some blocks in FIGS. 5A and 5B may be implemented by software, and other blocks may be implemented by hardware or a combination of hardware and software. In FIGS. 5A and 5B, one block may be subdivided into a plurality of blocks, a plurality of blocks may be integrated into one block, some blocks may be omitted, and blocks supporting other functions may be added.

Meanwhile, communications between the UEs 235 and 236 may be performed based on sidelink communication technology (e.g., ProSe communication technology, D2D communication technology). The sidelink communication may be performed based on a one-to-one scheme or a one-to-many scheme. When V2V communication is performed using sidelink communication technology, the UE 235 may refer to a communication node located in the first vehicle 100 of FIG. 1, and the UE 236 may refer to a communication node located in the second vehicle 110 of FIG. 1. When V2I communication is performed using sidelink communication technology, the UE 235 may refer to a communication node located in the first vehicle 100 of FIG. 1, and the UE 236 may refer to a communication node located in the infrastructure 120 of FIG. 1. When V2P communication is performed using sidelink communication technology, the UE 235 may refer to a communication node located in the first vehicle 100 of FIG. 1, and the UE 236 may refer to a communication node carried by the person 130.

The scenarios to which the sidelink communications are applied may be classified as shown below in Table 1 according to the positions of the UEs (e.g., the UEs 235 and 236) participating in the sidelink communications. For example, the scenario for the sidelink communications between the UEs 235 and 236 shown in FIG. 2 may be a sidelink communication scenario C.

TABLE 1

| Sidelink | | |
|---|---|---|
| Communication | | |
| Scenario | Position of UE 235 | Position of UE 236 |
| A | Out of coverage of | Out of coverage of |
| | base station 210 | base station 210 |
| B | In coverage of | Out of coverage of |
| | base station 210 | base station 210 |
| C | In coverage of | In coverage of |
| | base station 210 | base station 210 |
| D | In coverage of | In coverage of other |
| | base station 210 | base station |

Meanwhile, a user plane protocol stack of the UEs (e.g., the UEs 235 and 236) performing sidelink communications may be configured as follows.

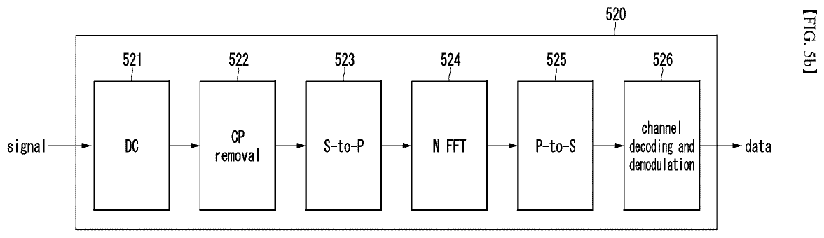

FIG. 6 is a block diagram illustrating a first exemplary embodiment of a user plane protocol stack of a UE performing sidelink communication.

As shown in FIG. 6, the UE 235 may be the UE 235 shown in FIG. 2 and the UE 236 may be the UE 236 shown in FIG. 2. The scenario for the sidelink communications between the UEs 235 and 236 may be one of the sidelink communication scenarios A to D of Table 1. The user plane protocol stack of each of the UEs 235 and 236 may comprise a physical (PHY) layer, a medium access control (MAC) layer, a radio link control (RLC) layer, and a packet data convergence protocol (PDCP) layer.

The sidelink communications between the UEs 235 and 236 may be performed using a PC5 interface (e.g., PC5-U interface). A layer-2 identifier (ID) (e.g., a source layer-2 ID, a destination layer-2 ID) may be used for the sidelink communications, and the layer 2-ID may be an ID configured for the V2X communications. Also, in the sidelink communications, a hybrid automatic repeat request (HARQ) feedback operation may be supported, and an RLC acknowledged mode (RLC AM) or an RLC unacknowledged mode (RLC UM) may be supported.

Meanwhile, a control plane protocol stack of the UEs (e.g., the UEs 235 and 236) performing sidelink communications may be configured as follows.

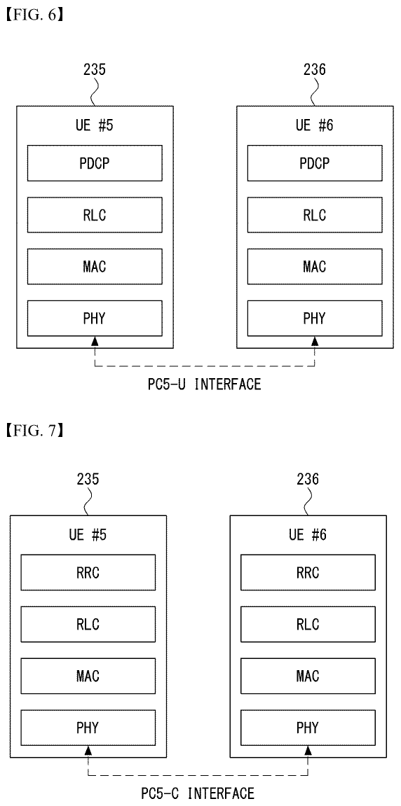

FIG. 7 is a block diagram illustrating a first exemplary embodiment of a control plane protocol stack of a UE performing sidelink communication, and FIG. 8 is a block diagram illustrating a second exemplary embodiment of a control plane protocol stack of a UE performing sidelink communication.

As shown in FIGS. 7 and 8, the UE 235 may be the UE 235 shown in FIG. 2 and the UE 236 may be the UE 236 shown in FIG. 2. The scenario for the sidelink communications between the UEs 235 and 236 may be one of the sidelink communication scenarios A to D of Table 1. The control plane protocol stack illustrated in FIG. 7 may be a control plane protocol stack for transmission and reception of broadcast information (e.g., Physical Sidelink Broadcast Channel (PSBCH)).

The control plane protocol stack shown in FIG. 7 may include a PHY layer, a MAC layer, an RLC layer, and a radio resource control (RRC) layer. The sidelink communications between the UEs 235 and 236 may be performed using a PC5 interface (e.g., PC5-C interface). The control plane protocol stack shown in FIG. 8 may be a control plane protocol stack for one-to-one sidelink communication. The control plane protocol stack shown in FIG. 8 may include a PHY layer, a MAC layer, an RLC layer, a PDCP layer, and a PC5 signaling protocol layer.

Meanwhile, channels used in the sidelink communications between the UEs 235 and 236 may include a Physical Sidelink Shared Channel (PSSCH), a Physical Sidelink Control Channel (PSCCH), a Physical Sidelink Discovery Channel (PSDCH), and a Physical Sidelink Broadcast Channel (PSBCH). The PSSCH may be used for transmitting and receiving sidelink data and may be configured in the UE (e.g., UE 235 or 236) by higher layer signaling. The PSCCH may be used for transmitting and receiving sidelink control information (SCI) and may also be configured in the UE (e.g., UE 235 or 236) by higher layer signaling.

The PSDCH may be used for a discovery procedure. For example, a discovery signal may be transmitted over the PSDCH. The PSBCH may be used for transmitting and receiving broadcast information (e.g., system information). Also, a demodulation reference signal (DM-RS), a synchronization signal, or the like may be used in the sidelink communications between the UEs 235 and 236. The synchronization signal may include a primary sidelink synchronization signal (PSSS) and a secondary sidelink synchronization signal (SSSS).

Meanwhile, a sidelink transmission mode (TM) may be classified into sidelink TMs 1 to 4 as shown below in Table 2.

TABLE 2

| Sidelink | |
|---|---|
| TM | Description |
| 1 | Transmission using resources scheduled by base station |
| 2 | UE autonomous transmission without scheduling of base station |
| 3 | Transmission using resources scheduled by base station in V2X |
| | communications |
| 4 | UE autonomous transmission without scheduling of base station |
| | in V2X communications |

When the sidelink TM 3 or 4 is supported, each of the UEs 235 and 236 may perform sidelink communications using a resource pool configured by the base station 210. The resource pool may be configured for each of the sidelink control information and the sidelink data.

The resource pool for the sidelink control information may be configured based on an RRC signaling procedure (e.g., a dedicated RRC signaling procedure, a broadcast RRC signaling procedure). The resource pool used for reception of the sidelink control information may be configured by a broadcast RRC signaling procedure. When the sidelink TM 3 is supported, the resource pool used for transmission of the sidelink control information may be configured by a dedicated RRC signaling procedure. In this case, the sidelink control information may be transmitted through resources scheduled by the base station 210 within the resource pool configured by the dedicated RRC signaling procedure. When the sidelink TM 4 is supported, the resource pool used for transmission of the sidelink control information may be configured by a dedicated RRC signaling procedure or a broadcast RRC signaling procedure. In this case, the sidelink control information may be transmitted through resources selected autonomously by the UE (e.g., UE 235 or 236) within the resource pool configured by the dedicated RRC signaling procedure or the broadcast RRC signaling procedure.

When the sidelink TM 3 is supported, the resource pool for transmitting and receiving sidelink data may not be configured. In this case, the sidelink data may be transmitted and received through resources scheduled by the base station 210. When the sidelink TM 4 is supported, the resource pool for transmitting and receiving sidelink data may be configured by a dedicated RRC signaling procedure or a broadcast RRC signaling procedure. In this case, the sidelink data may be transmitted and received through resources selected autonomously by the UE (e.g., UE 235 or 236) within the resource pool configured by the dedicated RRC signaling procedure or the broadcast RRC signaling procedure.

Hereinafter, sidelink communication methods will be described. Even when a method (e.g., transmission or reception of a signal) to be performed at a first communication node among communication nodes is described, a corresponding second communication node may perform a method (e.g., reception or transmission of the signal) corresponding to the method performed at the first communication node. That is, when an operation of a UE #1 (e.g., vehicle #1) is described, a UE #2 (e.g., vehicle #2) corresponding thereto may perform an operation corresponding to the operation of the UE #1. Conversely, when an operation of the UE #2 is described, the corresponding UE #1 may perform an operation corresponding to the operation of the UE #2. In exemplary embodiments described below, an operation of a vehicle may be an operation of a communication node located in the vehicle.

A sidelink signal may be a synchronization signal and a reference signal used for sidelink communication. For example, the synchronization signal may be a synchronization signal/physical broadcast channel (SS/PBCH) block, sidelink synchronization signal (SLSS), primary sidelink synchronization signal (PSSS), secondary sidelink synchronization signal (SSSS), or the like. The reference signal may be a channel state information-reference signal (CSI-RS), DM-RS, phase tracking-reference signal (PT-RS), cell-specific reference signal (CRS), sounding reference signal (SRS), discovery reference signal (DRS), or the like.

A sidelink channel may be a PSSCH, PSCCH, PSDCH, PSBCH, physical sidelink feedback channel (PSFCH), or the like. In addition, a sidelink channel may refer to a sidelink channel including a sidelink signal mapped to specific resources in the corresponding sidelink channel. The sidelink communication may support a broadcast service, a multicast service, a groupcast service, and a unicast service.

The base station may transmit system information (e.g., SIB12, SIB13, SIB14) and RRC messages including configuration information for sidelink communication (i.e., sidelink configuration information) to UE(s). The UE may receive the system information and RRC messages from the base station, identify the sidelink configuration information included in the system information and RRC messages, and perform sidelink communication based on the sidelink configuration information. The SIB12 may include sidelink communication/discovery configuration information. The SIB13 and SIB14 may include configuration information for V2X sidelink communication.

The sidelink communication may be performed within a SL bandwidth part (BWP). The base station may configure SL BWP(s) to the UE using higher layer signaling. The higher layer signaling may include SL-BWP-Config and/or SL-BWP-ConfigCommon. SL-BWP-Config may be used to configure a SL BWP for UE-specific sidelink communication. SL-BWP-ConfigCommon may be used to configure cell-specific configuration information.

Furthermore, the base station may configure resource pool(s) to the UE using higher layer signaling. The higher layer signaling may include SL-BWP-PoolConfig, SL-BWP-PoolConfigCommon, SL-BWP-DiscPoolConfig, and/or SL-BWP-DiscPoolConfigCommon. SL-BWP-PoolConfig may be used to configure a sidelink communication resource pool. SL-BWP-PoolConfigCommon may be used to configure a cell-specific sidelink communication resource pool. SL-BWP-DiscPoolConfig may be used to configure a resource pool dedicated to UE-specific sidelink discovery. SL-BWP-DiscPoolConfigCommon may be used to configure a resource pool dedicated to cell-specific sidelink discovery. The UE may perform sidelink communication within the resource pool configured by the base station.

The sidelink communication may support SL discontinuous reception (DRX) operations. The base station may transmit a higher layer message (e.g., SL-DRX-Config) including SL DRX-related parameter(s) to the UE. The UE may perform SL DRX operations based on SL-DRX-Config received from the base station. The sidelink communication may support inter-UE coordination operations. The base station may transmit a higher layer message (e.g., SL-InterUE-CoordinationConfig) including inter-UE coordination parameter(s) to the UE. The UE may perform inter-UE coordination operations based on SL-Inter UE-CoordinationConfig received from the base station.

The sidelink communication may be performed based on a single-SCI scheme or a multi-SCI scheme. When the single-SCI scheme is used, data transmission (e.g., sidelink data transmission, sidelink-shared channel (SL-SCH) transmission) may be performed based on one SCI (e.g., 1st-stage SCI). When the multi-SCI scheme is used, data transmission may be performed using two SCIs (e.g., 1st-stage SCI and 2nd-stage SCI). The SCI(s) may be transmitted on a PSCCH and/or a PSSCH. When the single-SCI scheme is used, the SCI (e.g., 1st-stage SCI) may be transmitted on a PSCCH. When the multi-SCI scheme is used, the 1st-stage SCI may be transmitted on a PSCCH, and the 2nd-stage SCI may be transmitted on the PSCCH or a PSSCH. The 1st-stage SCI may be referred to as ‘first-stage SCI’, and the 2nd-stage SCI may be referred to as ‘second-stage SCI’. A format of the first-stage SCI may include a SCI format 1-A, and a format of the second-stage SCI may include a SCI format 2-A, a SCI format 2-B, and a SCI format 2-C.

The SCI format 1-A may be used for scheduling a PSSCH and second-stage SCI. The SCI format 1-A may include at least one among priority information, frequency resource assignment information, time resource assignment information, resource reservation period information, demodulation reference signal (DMRS) pattern information, second-stage SCI format information, beta_offset indicator, number of DMRS ports, modulation and coding scheme (MCS) information, additional MCS table indicator, PSFCH overhead indicator, or conflict information receiver flag.

The SCI format 2-A may be used for decoding of a PSSCH. The SCI format 2-A may include at least one among a HARQ processor number, new data indicator (NDI), redundancy version (RV), source ID, destination ID, HARQ feedback enable/disable indicator, cast type indicator, or CSI request.

The SCI format 2-B may be used for decoding of a PSSCH. The SCI format 2-B may include at least one among a HARQ processor number, NDI, RV, source ID, destination ID, HARQ feedback enable/disable indicator, zone ID, or communication range requirement.

The SCI format 2-C may be used for decoding of a PSSCH. In addition, the SCI format 2-C may be used to provide or request inter-UE coordination information. The SCI format 2-C may include at least one among a HARQ processor number, NDI, RV, source ID, destination ID, HARQ feedback enable/disable indicator, CSI request, or providing/requesting indicator.

When a value of the providing/requesting indicator is set to 0, this may indicate that the SCI format 2-C is used to provide inter-UE coordination information. In this case, the SCI format 2-C may include at least one among resource combinations, first resource location, reference slot location, resource set type, or lowest subchannel indexes.

When a value of the providing/requesting indicator is set to 1, this may indicate that the SCI format 2-C is used to request inter-UE coordination information. In this case, the SCI format 2-C may include at least one among a priority, number of subchannels, resource reservation period, resource selection window location, resource set type, or padding bit(s).

Meanwhile, sidelink (SL) communication may support a beam management operation. The beam management operation may be supported in FR2 bands. In the present disclosure, the beam management operation may be referred to as a BM operation. The BM operation may be performed using channel state information-reference signal (CSI-RS). In this case, a constraint on the number of symbols within a transmittable SL slot may exist. For example, PSSCH symbols for PSSCH transmission may not be sufficiently secured. The BM operation may be performed using synchronization signal block (SSB). In this case, a constraint on SSB transmission may exist. For example, considering SSB transmission, a transmission time according to a triggering time for BM operation may be changed. Accordingly, inefficiency in SL communication may increase.

Beam management operations in an NR Uu link may be defined as follows.
Signals used for CSI measurement: CSI-RS set and/or SSB
channel quality indicator (CQI) metric for a beam: L1-reference signal received power (RSRP)
Maximum number of CSI reports per terminal: 4 (e.g., CSI reporting for 4 beams is possible)
Reported information: the largest L1-RSRP among L1-RSRPs of beams and/or differences between the largest L1-RSRP and L1-RSRPs of other beams
CSI-RS transmission type: CSI reporting type+channel used for CSI reporting
Periodic type: periodic CSI reporting+physical uplink control channel (PUCCH)
Semi-persistent type: periodic CSI reporting+PUCCH or semi-persistent CSI reporting+physical uplink shared channel (PUSCH)
Aperiodic type: aperiodic CSI reporting (e.g., aperiodic CSI reporting triggered by DCI with a CSI request field)+PUSCH
Beam adjustment may be performed for each of down transmission and reception beams. If beam reciprocity is satisfied between uplink and downlink, the BM operation (e.g., beam adjustment operation) may be performed only for downlink.

CSI-related operations in an NR SL link may be defined as follows.
Signals used for CSI measurement: CSI-RS set
CQI metric: L1-RSRP
Maximum CSI-RS ports: 2
CSI-RS transmission type: CSI reporting type+channel used for CSI reporting
Aperiodic type: aperiodic CSI reporting (e.g., aperiodic CSI reporting triggered by an SCI format 2-A or 2-C with a CSI request field)+PSSCH (e.g., MAC CE)

S-SSB related operations in NR communication may be defined as follows.
Unlike SSB transmission in an NR Uu link, S-SSB transmission in an NR SL link may be performed at a fixed periodicity. The fixed periodicity may be 160 ms.
As shown in Table 3 below, multiple S-SSBs may be transmitted in one S-SSB period depending on a frequency range (FR) and/or a subcarrier spacing (SCS).

TABLE 3

| FR | SCS | Number of S-SSBs within an S-SSB period |
|---|---|---|
| FR1 | 15 kHz | 1 |
| | 30 kHz | 1, 2 |
| | 60 kHz | 1, 2, 4 |
| FR2 | 60 kHz | 1, 2, 4, 8, 16, 32 |
| | 120 kHz | 1, 2, 4, 8, 16, 32, 64 |

In the present disclosure, the following terms may be defined to describe BM operations.

### Transmitting Terminal

A transmitting terminal may refer to a terminal that transmits data (e.g., SL data, user data) in SL communication. A transmitting terminal may be referred to as a TX terminal, transmitting UE, or TX UE. For convenience of description, a transmitting terminal may be referred to as a first terminal or a first UE. In the present disclosure, a term ‘terminal’ may be interpreted as a transmitting terminal depending on a context.

### Receiving Terminal

A receiving terminal may refer to a terminal that receives data (e.g., SL data, user data) in SL communication. A receiving terminal may be referred to as an RX terminal, receiving UE, or RX UE. For convenience of description, a receiving terminal may be referred to as a second terminal or a second UE. In the present disclosure, a term ‘terminal’ may be interpreted as a receiving terminal depending on a context.

### Beam Management-Reference Signal (BM-RS)

A BM-RS may be a reference signal used for measuring a beam quality (e.g., transmission and reception beam) between a transmitting terminal and a receiving terminal in SL communication. In other words, a BM-RS may be a reference signal used for BM operation. A beam quality measurement operation may be continuously performed. A BM-RS may be a CSI-RS (e.g., CSI-RS in existing SL communication), a modified CSI-RS, or an extended CSI-RS. Alternatively, a new reference signal for BM-RS may be defined.

### Beam State Information (BSI)

BSI may refer to beam information measured based on BM-RS. BSI may include at least one of a beam index, beam measurement information (e.g., beam quality information), or a calculation result of a beam measurement value. A beam index may be an index of a beam with the best quality or an index (or indexes) of beam(s) with beam quality equal to or greater than a threshold. Beam measurement information may include reference signal received power (RSRP), reference signal received quality (RSRP), received signal strength indicator (RSSI), and/or the like of beam(s).

### Scheduling Request for Beam Management (SR-BM)

An SR-BM may be used to request resources for BM operation (e.g., BSI request transmission, BM-RS transmission, and/or BSI report reception). A terminal may request resources for BM operation (e.g., BSI request transmission, BM-RS transmission, and/or BSI report reception) by transmitting an SR-BM to a base station.

### Response for Scheduling Request (Response-SR)

A base station may transmit a response-SR to a terminal as a response to an SR-BM. A response-SR may include information on resources for BM operation (e.g., BSI request transmission, BM-RS transmission, and/or BSI report reception). A response-SR may be a signaling message.

In a resource allocation (RA) mode 1, a base station may allocate resources for BM operation (e.g., BSI request transmission, BM-RS transmission, and/or BSI report reception) to a terminal (e.g., transmitting terminal and/or receiving terminal). The transmitting terminal may receive resource information (e.g., resource allocation information) for BM operation from the base station. Subsequently, in order to obtain beam information (e.g., beam measurement information, beam quality information, beam state information), the transmitting terminal may transmit a BSI request and/or BM-RS using the resources allocated by the base station. In the present disclosure, the beam information may refer to beam measurement information, beam quality information, and/or beam state information. The receiving terminal may receive the BM-RS from the transmitting terminal, generate beam information by performing a measurement operation on the BM-RS, and transmit the beam information to the transmitting terminal.

In other words, the receiving terminal may transmit BSI to the transmitting terminal, and the transmitting terminal may receive the BSI from the receiving terminal. Based on the above operation (e.g., BM operation), the transmitting terminal may determine and/or change a transmission beam, and the receiving terminal may determine and/or change a reception beam. In other words, a beam pair between a transmission beam of the transmitting terminal and a reception beam of the receiving terminal may be configured. In the present disclosure, signaling schemes for BM operation are proposed, and variations and/or extensions of the proposed signaling schemes may be possible. Additionally, combinations of the proposed signaling schemes with other signaling schemes may also be possible.

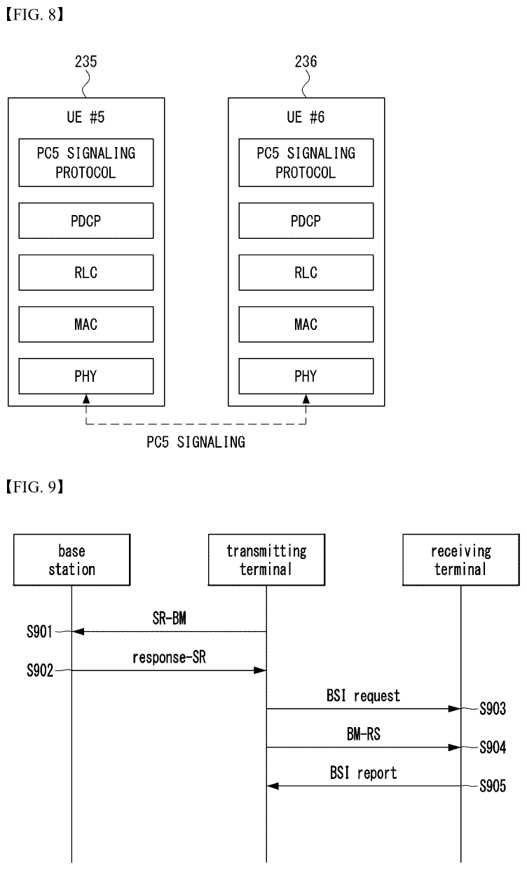

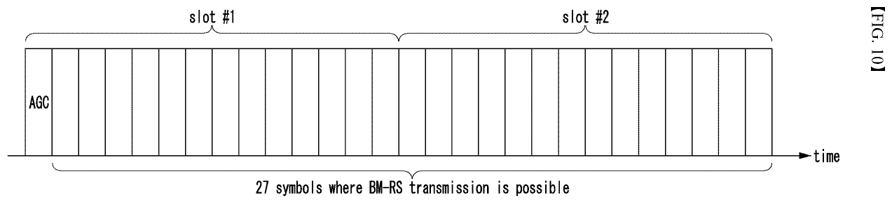

In an RA mode 2, without a signaling operation for resource allocation for BM operation between the base station and the transmitting terminal, the transmitting terminal may select resources for BM operation (e.g., BSI request transmission, BM-RS transmission, and/or BSI report reception) by performing a resource sensing/selection operation and may perform a BM operation using the selected resources. In the present disclosure, a ‘resource sensing/selection operation’ may refer to a resource sensing operation and/or a resource selection operation. The BM operation using the resources allocated by the base station in the RA mode 1 and the BM operation using the resources selected by the transmitting terminal in the RA mode 2 may be performed based on the same or a similar scheme. In the present disclosure, BM operations will be described based on the RA mode 1. However, the BM operations described in the present disclosure may be applied not only to communication systems supporting the RA mode 1 but also to communication systems supporting the RA mode 2. For example, the BM operations according to the RA mode 1 may be directly applied to a communication system supporting the RA mode 2. Alternatively, variations and/or extensions of the BM operations according to the RA mode 1 may be applied to a communication system supporting the RA mode 2. FIG. 9 is a sequence chart illustrating a first exemplary embodiment of BM operations.

As shown in FIG. 9, a transmitting terminal (e.g., a first UE) may transmit an SR-BM to a base station to request resource allocation for BM operation (S901). The transmitting terminal may transmit the SR-BM when a BM operation is required. Cases where a BM operation is required may include a case when a transmission beam of the transmitting terminal needs to be changed, a case when a reception beam of the receiving terminal needs to be changed, a case when a beam pair between the transmitting terminal and the receiving terminal needs to be changed, and/or a case when a beam failure occurs between the transmitting terminal and the receiving terminal. The base station may receive the SR-BM from the transmitting terminal and allocate resources for a BM operation of the transmitting terminal. The base station may transmit a response-SR, which includes resource allocation information for BM operation, to the transmitting terminal (S902). The transmitting terminal may receive the response-SR from the base station and identify the resource allocation information for BM operation included in the response-SR.

Each of the SR-BM and response-SR may be signaled over a Uu interface between the base station and the transmitting terminal. For example, each of the SR-BM and response-SR may be transmitted through at least one of higher-layer signaling, MAC signaling, or PHY signaling. A PHY signaling message may be transmitted on a PUCCH and/or PUSCH.

The SR-BM may include information (e.g., location information) on time and/or frequency resources required by the transmitting terminal for BSI request transmission, BM-RS transmission, and/or BSI report reception. In other words, the SR-BM may include resource request information. Time resource information may include at least one of information on the number of symbols, a start symbol index, an end symbol index, one or more symbol indexes, information on the number of slots, a start slot index, an end slot index, or one or more slot indexes. Frequency resource information may include at least one of information on the number of subchannels, a start subchannel index, an end subchannel index, one or more subchannel indexes, information on the number of resource blocks (RBs), a start RB index, an end RB index, one or more RB indexes, or an interlace index (or indexes).

Table 4 below represents the resource request information indicated by the SR-BM.

TABLE 4

| Indication bits | Time resources | Frequency resources |
|---|---|---|
| 00 | T1 slot(s) | F1 subchannel(s) |
| 01 | T2 slot(s) | F2 subchannel(s) |
| 10 | T3 slot(s) | F3 subchannel(s) |
| 11 | Semi-persistent | F4 subchannel(s) |

The SR-BM may include indication bits. The transmitting terminal may transmit an SR-BM set to ‘00’ to the base station to request allocation of T1 slot(s) and F1 subchannel(s). The T1 slot(s) may be T1 consecutive slot(s). Alternatively, the T1 slot(s) may have a fixed time interval. The F1 subchannel(s) may be F1 consecutive subchannel(s). Alternatively, the F1 subchannel(s) may have a fixed frequency interval.

The transmitting terminal may transmit an SR-BM set to ‘11’ to the base station to request the allocation of semi-persistent slot(s) (e.g., semi-persistent SL slot(s)) and F4 subchannel(s). In other words, to repeatedly use one or more consecutive slots at a fixed time interval, the transmitting terminal may transmit an SR-BM set to ‘11’ to the base station. In this case, the SR-BM may include at least one of the number of the one or more consecutive slots, a time interval of the one or more consecutive slots, information on a start slot among the one or more consecutive slots, or information on an end slot among the one or more consecutive slots.

For indicating resource information, requesting various resources, and/or indicating resources allocated in response to the request, the following operations may be performed. The base station may preconfigure information on resources that are allowed for use to the transmitting terminal through signaling. The transmitting terminal may transmit an SR-BM to the base station to indicate a specific resource among the resources configured by the base station. Based on the indication bits defined in Table 4, aperiodic BM operations and/or semi-persistent BM operations may be performed. In the present disclosure, signaling may refer to at least one of higher-layer signaling (e.g., SI signaling, RRC signaling), MAC signaling, or PHY signaling.

Instead of the indication bits, the SR-BM may be configured as a sequence. For example, four different sequences may indicate requests for four different resources. By transmitting an SR-BM configured as one of the four different sequences to the base station, the transmitting terminal may request allocation of resources corresponding to the selected sequence. The SR-BM may be used to request allocation of only time resources or only frequency resources.

After receiving the SR-BM, the base station may transmit a response-SR to the transmitting terminal, including time resource information and/or frequency resource information. The time resource information may include information on an interval between time resources. If the SR-BM set to ‘11’ is received, the base station may allocate one or more consecutive slots that are repeatedly used at a fixed time interval to the transmitting terminal. In this case, the base station may transmit a response-SR to the transmitting terminal, including at least one of the number of the one or more consecutive slots, an interval of the one or more consecutive slots, information on a start slot among the one or more consecutive slots, or information on an end slot among the one or more consecutive slots.

For indicating the resources allocated by the base station, the base station may preconfigure information on various types of allocatable resources to the transmitting terminal through signaling. The base station may transmit resource allocation information (e.g., response-SR) to the transmitting terminal, indicating a specific resource among the preconfigured resources. The response-SR may be transmitted through signaling over a Uu interface between the base station and the transmitting terminal.

The transmitting terminal may receive the response-SR from the base station and identify the resource allocation information (e.g., time resource information and/or frequency resource information) included in the response-SR. The transmitting terminal may transmit a BSI request to the receiving terminal (e.g., a second UE) in the resource(s) indicated by the response-SR (e.g., resource allocation information) (S903). The receiving terminal may receive the BSI request from the transmitting terminal and determine that a BSI report is requested based on the BSI request. The BSI request may trigger transmission of a BSI report. The response-SR may be received not only by the transmitting terminal that transmitted the SR-BM but also by the receiving terminal. If the response-SR is received from the base station, the receiving terminal may perform a monitoring operation for BSI request reception in the resource(s) indicated by the response-SR.

After transmitting the BSI request, the transmitting terminal may transmit BM-RS(s) to the receiving terminal in the resource(s) indicated by the response-SR (e.g., resource allocation information) (S904). The transmission resource(s) for BM-RS(s) may be indicated by ‘resource allocation information included in the BSI request’ or ‘resource allocation information included in SCI containing the BSI request’. The transmission resource(s) for BM-RS(s) indicated by the resource allocation information included in the BSI request or the SCI may belong to the resources allocated by the base station in step S902.

The receiving terminal may receive BM-RS(s) from the transmitting terminal and generate BSI (e.g., beam quality information, beam measurement information) by performing a measurement operation on the BM-RS(s). The response-SR may be received not only by the transmitting terminal that transmitted the SR-BM but also by the receiving terminal. If the response-SR is received from the base station, the receiving terminal may perform a monitoring operation for BM-RS reception in the resource(s) indicated by the response-SR. The receiving terminal may transmit a BSI report to the transmitting terminal (S905). The transmitting terminal may receive the BSI report from the receiving terminal and perform BM operations (e.g., beam determination, beam change, beam configuration) based on the BSI report. The receiving terminal may perform BM operations (e.g., beam determination, beam change, beam configuration) based on the BSI. Based on these operations, a beam pair between a transmission beam of the transmitting terminal and a reception beam of the receiving terminal may be configured.

In step S903 and/or S904, the transmitting terminal may explicitly or implicitly indicate the execution of the receiving terminal's reception beam change (or determination) operation based on BM operations. In this case, the receiving terminal may perform the reception beam change (or determination) operation after receiving BM-RS(s) without transmitting a BSI report. The transmitting terminal may not expect to receive a BSI report from the receiving terminal. Alternatively, the receiving terminal may perform the reception beam change (or determination) operation after transmitting a BSI report.

The BSI request, BM-RS, and/or BSI report may be transmitted and received within at least one resource pool (RP), such as an RP allocated for SL communication (e.g., SL data communication) (SL-RP) or a dedicated RP for BM operation (e.g., BM-RP). If both SL-RP and BM-RP are used (e.g., operated), RP configuration information may include information indicating whether an RP configured by the RP configuration information is an SL-RP or a BM-RP. The base station may generate RP configuration information and transmit the RP configuration information to terminal(s) (e.g., transmitting terminal and/or receiving terminal) through signaling. As another method, the transmitting terminal may generate RP configuration information and transmit the RP configuration information to the receiving terminal through signaling. The transmitting terminal and/or the receiving terminal may receive the RP configuration information. The transmitting terminal may perform a transmission operation of a BSI request, a transmission operation of BM-RS(s), and/or a reception operation of a BSI report within the RP indicated by the RP configuration information. The receiving terminal may perform a reception operation of a BSI request, a reception operation of BM-RS(s), and/or a transmission operation of a BSI report within the RP indicated by the RP configuration information.

The same frequency resources (e.g., the same frequency band) may be allocated (e.g., configured) for both a BM-RP and SL-RP, and different time resources may be allocated (e.g., configured) for the BM-RP and SL-RP.

As another method, a frequency band of a BM-RP may include a part or the entirety of a frequency band of an SL-RP. A frequency band of a BM-RP may include both a frequency band of an SL-RP and a frequency band adjacent to the frequency band of the SL-RP. Time resources of a BM-RP and an SL-RP may be configured so that they do not overlap. Alternatively, a frequency band of an SL-RP may include a part or the entirety of a frequency band of a BM-RP.

Frequency resources of a BM-RP may be configured to ensure that beam information measured in the BM-RP is validly used in an SL-RP. The base station may preconfigure multiple resource regions for an SL-RP and/or multiple resource regions for a BM-RP to the terminal (e.g., transmitting terminal and/or receiving terminal) through signaling (e.g., higher-layer signaling) and may allocate a specific resource region among the multiple resource regions as a resource region for the SL-RP and/or BM-RP to the terminal. An SL-RP and a BM-RP may be paired (e.g., mapped), and a pair of the SL-RP and BM-RP may be configured to the terminal. In other words, the base station may transmit mapping information between the SL-RP and BM-RP to the terminal through signaling (e.g., higher-layer signaling). An SL-RP paired (e.g., mapped) with a BM-RP may be an SL-RP in which beam information measured in the BM-RP is validly used. The terminal may perform a BM operation in a BM-RP and may perform SL communication in an SL-RP paired with the BM-RP by using a beam (e.g., determined beam, configured beam) changed by the BM operation.

Three BM signals (e.g., BSI request, BM-RS, and BSI report) described above may be transmitted in the same RP or in different RPs. In this case, the BM signals may be transmitted according to the following cases.
Case 1: Three BM signals (e.g., BSI request, BM-RS, and BSI report) are transmitted within an SL-RP.
Case 2: Two BM signals (e.g., BSI request and BSI report) are transmitted within an SL-RP, and one BM signal (e.g., BM-RS) is transmitted within a BM-RP.
Case 3: Three BM signals (e.g., BSI request, BM-RS, and BSI report) are transmitted within a BM-RP.

In Case 1, BM operations may be performed without operating an additional RP other than the SL-RP. However, a resource utilization for transmitting the BSI request, BM-RS, and BSI report within the SL-RP may increase. Consequently, traffic congestion may occur. In this case, resources for SL data transmission within the SL-RP may be insufficient, and a transmission collision between terminals may occur in a slot (e.g., SL slot).

In Case 3, since the BM operation is performed in an additional RP (e.g., BM-RP), the issues of Case 1 may be resolved. However, the receiving terminal may need to perform an additional monitoring operation (e.g., decoding operation, blind decoding operation) in the BM-RP in addition to the SL-RP to detect the BSI request. Therefore, the load and/or energy consumption of the receiving terminal may increase.

In Case 2, since only the BM-RS is transmitted through the BM-RP, the issues of Case 1 (e.g., traffic congestion within the SL-RP) may be alleviated. Since the BSI request is transmitted through the SL-RP in Case 2, the receiving terminal only needs to perform a monitoring operation (e.g., decoding operation, blind decoding operation) in the SL-RP to detect the BSI request, thereby mitigating the issues of Case 3. When only the BM-RS is transmitted in the BM-RP, resource allocation within the SL-RP may be performed more flexibly. In other words, resource allocation within the SL-RP may be performed in a time unit smaller than a slot (e.g., a symbol unit).

### [Case 1]

In Case 1, the three BM signals may be transmitted and received within an SL-RP. A response-SR may include resource information for BSI request transmission, BM-RS transmission, and/or BSI report reception within the SL-RP.

Additionally, the response-SR may include resource information for BSI report transmission within the SL-RP. When the response-SR includes resource information for BSI report transmission, the transmitting terminal may transmit a BSI request including resource information for BSI report transmission to the receiving terminal. The receiving terminal may receive the BSI request from the transmitting terminal, identify the resource information included in the BSI request, and transmit a BSI report in resource(s) indicated by the resource information. When the BSI request is included in SCI, the resource information for BSI report transmission may be included in the SCI.

The transmitting terminal may transmit the SCI including the BSI request in a specific slot and may transmit BM-RS(s) in a slot scheduled by the SCI (e.g., a scheduled PSSCH, a reserved slot, or a reserved PSSCH). The SCI including the BSI request may be transmitted in a standalone form or in a two-stage SCI form. The SCI may include information indicating that reserved resource(s) (e.g., scheduled resource(s), allocated resource(s)) is a resource for BM-RS transmission. For example, a 1-bit indicator included in the SCI may indicate that the reserved slot is a resource for BM-RS transmission.

A new SCI and/or a new SCI field for indicating the BM-RS transmission resource may be defined. The new SCI may include information indicating that the reserved resource is a resource for BM-RS transmission. The new SCI field within the SCI may include information indicating that the reserved resource is a resource for BM-RS transmission. The new SCI for BM operation may be defined as an SCI format 2-D. When a value of a second-stage SCI format field included in an SCI format 1-A is set to 11, it may indicate that the SCI format 2-D is used. A resource reserved by the SCI format 2-D may be a resource for BM-RS transmission. In other words, it may be indicated that the resource reserved by the SCI format 2-D is for BM-RS transmission. Alternatively, a new first-stage SCI format (e.g., SCI format 1-B) for BM operation may be defined. In this case, a resource reserved by the SCI format 1-B may be a resource for BM-RS transmission. In other words, it may be indicated that the resource reserved by the SCI format 1-B is for BM-RS transmission.

The BSI request may include transmission scheme information for BM-RS transmission. The transmission scheme information may indicate a scheme in which the transmitting terminal transmits BM-RS(s) using the same transmission beam, a scheme in which the transmitting terminal transmits BM-RS(s) using different transmission beams, or a scheme in which the transmitting terminal transmits BM-RS(s) using different transmission beams based on a beam sweeping manner. In other words, the transmission scheme information may be information on a pattern of the transmission beam(s) of the transmitting terminal. When the two-stage SCI procedure is used, some of the above-described information elements may be transmitted through first-stage SCI, and the remaining information elements may be transmitted through second-stage SCI. For example, first-stage SCI may include information indicating that a reserved resource is a resource for BM-RS transmission, and second-stage SCI associated with the first-stage SCI may include information on the reserved resource for BM-RS transmission and/or information on a transmission scheme for BM-RS(s) (e.g., pattern of transmission beam(s)).

In Case 1, the transmitting terminal may transmit the SCI including the BSI request and may transmit BM-RS(s) in a PSSCH region within a slot in which the SCI is transmitted. In this case, the SCI may be transmitted in a standalone form or in a two-stage SCI form. The SCI may include information indicating that the slot in which the SCI is transmitted is a resource for BM-RS transmission. For example, a 1-bit indicator included in the SCI may indicate that the slot in which the SCI is transmitted is a resource for BM-RS transmission.

A new SCI format and/or a new SCI field (e.g., a reserved resource field for BM-RS) for BM-RS transmission may indicate that a current slot (e.g., a slot in which the new SCI format and/or new SCI field is transmitted) is a resource for BM-RS transmission. The new SCI for BM operation may be defined as an SCI format 2-D. When a value of a second-stage SCI format field included in an SCI format 1-A is set to 11, it may indicate that the SCI format 2-D is used. A resource reserved by the SCI format 2-D may be a resource for BM-RS transmission. In other words, it may be indicated that the resource reserved by the SCI format 2-D is for BM-RS transmission. Alternatively, a new first-stage SCI format (e.g., SCI format 1-B) for BM operation may be defined. In this case, a resource reserved by the SCI format 1-B may be a resource for BM-RS transmission. In other words, it may be indicated that the resource reserved by the SCI format 1-B is for BM-RS transmission.

The BSI request may include transmission scheme information for BM-RS transmission. The transmission scheme information may indicate a scheme in which the transmitting terminal transmits BM-RS(s) using the same transmission beam, a scheme in which the transmitting terminal transmits BM-RS(s) using different transmission beams, or a scheme in which the transmitting terminal transmits BM-RS(s) using different transmission beams based on a beam sweeping manner. In other words, the transmission scheme information may be information on a patten of the transmission beam(s) of the transmitting terminal. When the two-stage SCI procedure is used, some of the above-described information elements may be transmitted through first-stage SCI, and the remaining information elements may be transmitted through second-stage SCI. For example, first-stage SCI may include information indicating that a current slot (e.g., a slot in which the first-stage SCI is transmitted or a slot in which second-stage SCI associated with the first-stage SCI is transmitted) is a resource for BM-RS transmission and/or transmission scheme information for BM-RS (e.g., patten of transmission beam(s)), while the second-stage SCI associated with the first-stage SCI may include information on reserved resources for BM-RS transmission.

In the exemplary embodiments for Case 1 described above, the SCI may include information on a sequence type, a multiplexing scheme, and/or a resource mapping scheme of BM-RS(s). In other words, the SCI may include some or all of information elements needed for the terminal to receive the BM-RS(s). When the two-stage SCI procedure is used, some of the above-described information elements may be transmitted through first-stage SCI, while the remaining information elements may be transmitted through second-stage SCI.

### [Case 2]

In Case 2, a BSI request and BSI report may be transmitted within a SL-RP, while BM-RS(s) may be transmitted within a BM-RP. To support this operation, a response-SR may include resource information for transmission of the BSI request and BSI report in the SL-RP and resource information for transmission of the BM-RS(s) in the BM-RP. When the response-SR includes resource information for the transmission of the BSI report, the transmitting terminal may transmit a BSI request including resource information for the transmission of the BSI report to the receiving terminal. The receiving terminal may receive the BSI request from the transmitting terminal, identify the resource information included in the BSI request, and transmit the BSI report in resource(s) indicated by the resource information. When the BSI request is included in SCI, the resource information for the transmission of the BSI report may be included in the SCI.

The transmitting terminal may transmit the SCI including the BSI request in a slot within the SL-RP and may transmit the BM-RS in a slot scheduled by the SCI (e.g., scheduled PSSCH, reserved slot, or reserved PSSCH) within the BM-RP. The SCI including the BSI request may be transmitted in a standalone form or in a two-stage SCI form. The SCI may include information indicating that a reserved resource (e.g., scheduled resource, allocated resource) is a resource for BM-RS transmission. For example, a 1-bit indicator included in the SCI may indicate that a reserved slot is a resource for BM-RS transmission within the BM-RP.

A new SCI and/or a new SCI field for indicating BM-RS transmission resources may be defined. The new SCI may include information indicating that the reserved resource is a resource for BM-RS transmission. The new SCI field within the SCI may include information indicating that the reserved resource is a resource for BM-RS transmission. The new SCI for BM operation may be defined as an SCI format 2-D. When a value of a second-stage SCI format field included in the SCI format 1-A is set to 11, it may indicate that the SCI format 2-D is used. A resource reserved by the SCI format 2-D may be a resource for BM-RS transmission. In other words, it may be indicated that the resource reserved by the SCI format 2-D is for BM-RS transmission. Alternatively, a new first-stage SCI format (e.g., SCI format 1-B) for BM operation may be defined. In this case, a resource reserved by the SCI format 1-B may be a resource for BM-RS transmission. In other words, it may be indicated that the resource reserved by the SCI format 1-B is for BM-RS transmission.

The BSI request may include transmission scheme information for BM-RS transmission. The transmission scheme information may indicate a scheme in which the transmitting terminal transmits BM-RS(s) using the same transmission beam, a scheme in which the transmitting terminal transmits BM-RS(s) using different transmission beams, or a scheme in which the transmitting terminal transmits BM-RS(s) using different transmission beams based on a beam sweeping manner. In other words, the transmission scheme information may be information on a patten of the transmission beam(s) of the transmitting terminal. The SCI may include a sequence type, a multiplexing scheme, and/or a resource mapping scheme of BM-RS(s). In other words, the SCI may include some or all of the information elements needed for the terminal to receive the BM-RS(s). When the two-stage SCI procedure is used, some of the above-described information elements may be transmitted through first-stage SCI, while the remaining information elements may be transmitted through second-stage SCI. For example, first-stage SCI may include information indicating that a reserved resource is a resource for BM-RS transmission, while second-stage SCI associated with the first-stage SCI may include information on the reserved resource for BM-RS transmission and/or transmission scheme information for BM-RS(s) (e.g., information on a pattern of beam(s)).

In Case 2, the BM-RP may be dedicated resources (e.g., dedicated RP) for BM-RS transmission. A resource allocation unit in the BM-RP may be configured and/or operated differently from a resource allocation unit in the SL-RP (e.g., one-slot unit). For example, time resources allocated for BM-RS transmission may span multiple slots. The multiple slots may be consecutive slots or non-consecutive slots. In each slot, all symbols may be used for BM-RS transmission. Alternatively, only some symbols in each slot may be used (e.g., allocated) for BM-RS transmission. Alternatively, symbols with a specific time interval within a single slot may be allocated for BM-RS transmission (e.g., periodic BM-RS transmission). An allocation method of BM-RS transmission symbols within a single slot, variations of the allocation method, extensions of the allocation method, and/or combinations of the allocation method with other methods may be applied to the allocation of BM-RS transmission symbols across multiple slots (e.g., consecutive slots or non-consecutive slots).

A symbol first used for BM-RS transmission may be an automatic gain control (AGC) symbol. Any known signal between the transmitting terminal and the receiving terminal may be transmitted as the AGC symbol. A specific BM-RS may be transmitted based on configuration information between the transmitting terminal and the receiving terminal. The specific BM-RS may be transmitted in the AGC symbol. The base station may transmit resource allocation information for BM-RS transmission to the transmitting terminal through signaling. The transmitting terminal may receive the resource allocation information for BM-RS transmission from the base station. The resource allocation information may include information on multiple candidate resources for BM-RS transmission. The transmitting terminal may transmit SCI including information indicating a specific candidate resource among the multiple candidate resources configured by the base station to the receiving terminal. The receiving terminal may receive the SCI from the transmitting terminal and determine the resource for BM-RS transmission indicated by the SCI. The transmitting terminal may transmit BM-RS(s) in the resource indicated by the SCI, and the receiving terminal may receive (e.g., detect, measure) the BM-RS in the resource indicated by the SCI. Based on the above operations, the resource for BM-RS transmission may be configured in aperiodic or semi-static manner.

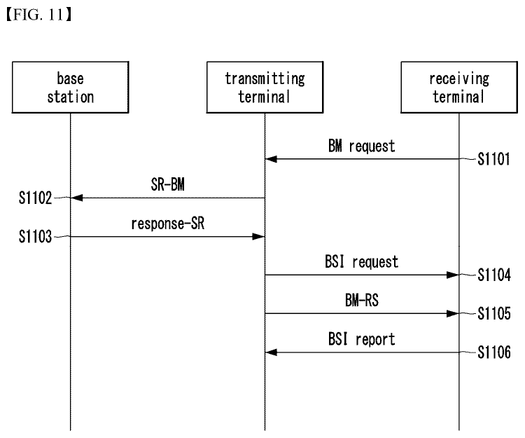

FIG. 10 is a conceptual diagram illustrating a first exemplary embodiment of a BM-RS transmission method.

As shown in FIG. 10, a transmitting terminal may transmit BM-RS(s) within a BM-RP. Within the BM-RP, two slots may be allocated for BM-RS transmission. In other words, symbols (e.g., 27 symbols) included in the two slots within the BM-RP may be candidate resources for BM-RS transmission. Each slot may include 14 symbols, and the first symbol of a slot #1 may be an AGC symbol. The AGC symbol may be used for AGC operations. The AGC symbol may not be used for BM-RS transmission. In this case, the candidate resources for BM-RS transmission within the two slots may be 27 symbols. Depending on resource allocation for BM-RS transmission, the transmitting terminal may transmit BM-RS(s) using all symbols (e.g., 27 symbols), some symbols, consecutive symbols, or non-consecutive symbols within the two slots. The transmitting terminal may transmit the BM-RS(s) periodically or aperiodically.

The symbols in which the BM-RS(s) is transmitted may be referred to as BM-RS symbols. The transmitting terminal may transmit the BM-RS(s) in the BM-RS symbols using either the same transmission beam or different transmission beams. The BM-RS(s) may be transmitted based on a beam sweeping manner. In this case, a beam sweeping pattern for BM-RS transmission may be configured, and the transmitting terminal may transmit the BM-RS(s) based on the beam sweeping pattern. The base station may configure various types of BM-RS resource allocation information and various types of beam sweeping patterns for the terminal (e.g., transmitting terminal and/or receiving terminal) through signaling. The transmitting terminal may transmit a BSI request including information indicating a specific configuration among the configurations configured by the base station to the receiving terminal. The BM operation between the transmitting terminal and the receiving terminal may be performed based on the configuration indicated by the transmitting terminal.

### [Case 3]

In Case 3, all BM signals (e.g., BSI request, BM-RS, and BSI report) may be transmitted and received within a BM-RP. To support this operation, a response-SR may include resource information for BSI request transmission and BM-RS transmission within the BM-RP. Additionally, the response-SR may further include resource information for BSI report transmission. When the response-SR includes resource information for BSI report transmission, the transmitting terminal may transmit a BSI request including resource information for BSI report transmission to the receiving terminal. The receiving terminal may receive the BSI request from the transmitting terminal, identify the resource information included in the BSI request, and transmit a BSI report in resource(s) indicated by the resource information. When the BSI request is included in SCI, the resource information for BSI report transmission may also be included in the SCI.

In Case 3, both a BSI request and BM-RS(s) may be transmitted within the BM-RP. Therefore, the BSI request and BM-RS transmission operations defined in Case 1 within the SL-RP, variations of those transmission operations, extensions of those transmission operations, and/or combinations of those transmission operations with other operations may be applied to Case 3. However, since only BM operations are performed within the BM-RP, the BSI request may not need to indicate that a reserved resource is a resource for BM-RS transmission within the BM-RP. When the BSI request and BM-RS are transmitted sequentially in the time domain and/or the BSI request including resource allocation information (e.g., resource reservation information) is transmitted, and then the BM-RS is transmitted in the resource indicated by the BSI request, unlike Case 1, the BSI request may not include information indicating whether the resource specified by the BSI request is a resource within the BM-RP and/or information indicating whether the resource specified by the BSI request is a reserved resource for BM-RS.

In a resource allocation procedure for BM operation, when both the SL-RP and BM-RP are operated as in Case 2, the SR-BM may include resource allocation request information for both the SL-RP and BM-RP. Table 4 for the BM-RP and Table 4 for the SL-RP may be configured and/or operated independently. Alternatively, resource allocation for both the SL-RP and BM-RP may be requested based on a single table (e.g., a common table). When a common table is used, a 1-bit indicator may be additionally used to distinguish between the resource allocation request for the SL-RP and the resource allocation request for the BM-RP within the SR-BM. Alternatively, fields within the SR-BM may be structured as a subfield for the resource allocation request of the SL-RP and a subfield for the resource allocation request of the BM-RP.

BM-RS transmission may be performed in the SL-RP or BM-RP. In other words, the transmitting terminal may select an RP for BM-RS transmission and perform BM-RS transmission in the selected RP, such as the SL-RP or BM-RP. In this case, a combination of Case 1 and Case 2 may be used. To support this operation, the BSI request may include information indicating the RP in which the BM-RS is transmitted.

In Case 1, Case 2, and/or Case 3, the receiving terminal may perform a monitoring operation, such as a decoding operation or a blind decoding operation, to receive the BSI request, detect the BSI request, receive the BM-RS from the transmitting terminal in the resource indicated by the BSI request, perform measurement on the BM-RS to generate the BSI, and transmit the BSI report to the transmitting terminal. Information necessary to support the operation of the receiving terminal, such as additional information, may be transmitted to the receiving terminal. The necessary information may be included in the BSI request.

A combination of Case 1, Case 2, and Case 3, an extension of the combination, and/or a variation of the combination may be used. To operate this combination, the SR-BM may include indication information for distinguishing each case.

FIG. 11 is a sequence chart illustrating a second exemplary embodiment of a BM operation.

As shown in FIG. 11, when a BM operation is required, a receiving terminal (e.g., second UE) may transmit a BM request to a transmitting terminal (e.g., first UE) (S1101). Cases in which a BM operation is required may include a case when a transmission beam of the transmitting terminal needs to be changed, a case when a reception beam of the receiving terminal needs to be changed, a case when a beam pair between the transmitting terminal and the receiving terminal needs to be changed, and/or a case when a beam failure occurs between the transmitting terminal and the receiving terminal. The BM request may include information regarding a reason why a BM operation is required. The transmitting terminal may receive the BM request from the receiving terminal. When the BM request is received from the receiving terminal, the transmitting terminal may perform a BM operation. In other words, after receiving the BM request, the transmitting terminal may transmit an SR-BM to the base station (S1102). Alternatively, the transmitting terminal may determine whether to perform a BM operation based on the BM request (e.g., information included in the BM request). When it is determined that a BM operation is to be performed, the transmitting terminal may transmit an SR-BM to the base station. When it is determined that a BM operation is not to be performed, the transmitting terminal may not transmit an SR-BM to the base station. The execution of the BM operation may be triggered by the BM request.

The second exemplary embodiment illustrated in FIG. 11 may further include step S1101 compared to the first exemplary embodiment illustrated in FIG. 9. Steps following step S1101 in FIG. 11 may be performed in the same or a similar manner as the steps in FIG. 9. For example, steps S1102, S1103, S1104, S1105, and S1106 in FIG. 11 may be performed in the same or a similar manner as steps S901, S902, S903, S904, and S905 in FIG. 9, respectively.

A beam pair problem (e.g., beam failure problem) between the transmitting terminal and the receiving terminal may first be recognized (or detected) at the receiving terminal. In the first exemplary embodiment of FIG. 9, the receiving terminal may detect a beam pair problem and transmit a CSI report to the transmitting terminal to notify the transmitting terminal of the necessity of a BM operation for beam pair change. In the first exemplary embodiment of FIG. 9, the execution of a CSI report procedure based on CSI-RS may be required. The transmitting terminal may receive the CSI report from the receiving terminal and determine whether to perform a BM operation based on the CSI report. The CSI report may be used to trigger the BM operation. The triggering operation of the CSI report may be performed by the transmitting terminal. When periodic CSI reporting is triggered, and the CSI reporting period is long, the receiving terminal may not be able to immediately transmit a CSI report even when the receiving terminal recognizes the beam pair problem with the transmitting terminal. In this case, the transmitting terminal may recognize the beam pair problem with a delay.

In the first exemplary embodiment of FIG. 9, when the operation of periodic CSI reporting is not supported, the operation of periodic BSI reporting is not supported, and/or the reporting period of CSI reporting/BSI reporting is long, the transmitting terminal may not be able to trigger the BM operation at the time when the BM operation is required due to the beam pair problem.

To solve the above-described problem, in the second exemplary embodiment of FIG. 11, when the receiving terminal requires execution of a BM operation, the receiving terminal may transmit a BM request to the transmitting terminal. The BM request may be transmitted to the transmitting terminal through signaling. The transmitting terminal may trigger the BM operation based on the BM request. In other words, the transmitting terminal may initiate the BM operation based on the BM request without relying on CSI reporting and/or BSI reporting.

The exemplary embodiments according to Table 4, FIG. 9, and FIG. 10, variations of the exemplary embodiments, extensions of the exemplary embodiments, and/or a combination of the exemplary embodiments with other exemplary embodiments may be applied to the exemplary embodiment of FIG. 11. In the exemplary embodiments according to Table 4, FIG. 9, FIG. 10, and FIG. 11, the base station may configure (e.g., allocate) resources (e.g., periodic resources, semi-static resources, aperiodic resources) for the transmission of the BSI request, BM-RS, and/or BSI report to the transmitting terminal without performing a transmission and reception procedure of BM signals (e.g., SR-BM and/or response-SR) between the transmitting terminal and the base station. The operation of configuring resources for the transmission of the BSI request, BM-RS, and/or BSI report to the transmitting terminal may be performed in a Uu interface between the base station and the transmitting terminal. The resource information for the transmission of the BSI request, BM-RS, and/or BSI report may be transmitted to the transmitting terminal through signaling. The transmitting terminal may identify resources configured by the base station (e.g., allocated resources) and perform the transmission operation of the BSI request, the transmission operation of the BM-RS, and/or the reception operation of the BSI report using the determined resources.

In the RA Mode 2, the transmitting terminal may select resources by performing a resource sensing/selection operation and may perform the transmission operation of the BSI request, the transmission operation of the BM-RS, and/or the reception operation of the BSI report in the selected resources without performing a transmission and reception procedure of BM signals (e.g., SR-BM and/or response-SR) between the transmitting terminal and the base station, according to the exemplary embodiments of Table 4, FIG. 9, FIG. 10, and FIG. 11. The transmitting terminal may receive the BSI report from the receiving terminal and determine (e.g., change, configure) a beam based on the BSI report. In other words, when the first exemplary embodiment of FIG. 9 is applied to the RA mode 2, steps S901 and S902 may not be performed, while steps S903, S904, and S905 may be performed. When the second exemplary embodiment of FIG. 11 is applied to the RA Mode 2, steps S1102 and S1103 may not be performed, while steps S1101, S1104, S1105, and S1106 may be performed.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

1. A method of a first user equipment (UE), comprising:
transmitting a scheduling request (SR)-beam management (BM) requesting resource allocation for a BM operation to a base station;
in response to the SR-BM, receiving a response-SR including resource allocation information from the base station; and
performing the BM operation with a second UE based on resources indicated by the resource allocation information.

2. The method according to claim 1, wherein the performing of the BM operation comprises:
transmitting a beam state information (BSI) request to the second UE based on the resources indicated by the resource allocation information;
transmitting a BM-reference signal (RS) to the second UE based on the resources indicated by the resource allocation information;
receiving a BSI report including beam measurement information based on the BM-RS from the second UE; and
managing a transmission beam of the first UE based on the beam measurement information included in the BSI report,
wherein the BSI request triggers transmission of the BSI report.

3. The method according to claim 2, wherein the BSI request is included in sidelink control information (SCI) transmitted by the first UE to the second UE, and the BM-RS is transmitted on a physical sidelink shared channel (PSSCH) scheduled by the SCI.

4. The method according to claim 2, wherein a BM-resource pool (RP) for the BM operation is configured independently from a sidelink-resource pool (SL-RP) for SL communication between the first UE and the second UE, and at least one of the BSI request, the BM-RS, or the BSI report is transmitted and received within the BM-RP.

5. The method according to claim 4, wherein a pair of the BM-RP and the SL-RP is configured to the first UE, and at least one of a transmission beam of the first UE or a reception beam of the second UE determined by the BM operation within the BM-RP is used for the SL communication between the first UE and the second UE within the SL-RP paired with the BM-RP.

6. The method according to claim 4, wherein the resource allocation information of the response-SR includes information on resources for the SL-RP and information on resources for the BM-RP.

7. The method according to claim 2, wherein the BSI request includes transmission scheme information of the BM-RS, and the transmission scheme information indicates a scheme in which the first UE transmits the BM-RS using a same transmission beam or a scheme in which the first UE transmits the BM-RS based on a beam sweeping manner.

8. The method according to claim 2, wherein the BSI request includes resource information for transmission of the BSI report, and the BSI report is received from resources indicated by the resource information included in the BSI request.

9. The method according to claim 2, further comprising: receiving a BM request from the second UE indicating that the BM operation is required, wherein a transmission operation of the SR-BM is triggered based on the BM request.

10. The method according to claim 1, wherein the SR-BM is transmitted when the BM operation is required, and cases when the BM operation is required include at least one of a case when a transmission beam of the first UE needs to be change, a case when a reception beam of the second UE needs to be changed, a case when a beam pair between the first UE and the second UE needs to be changed, or a case when a beam failure occurs between the first UE and the second UE.

11. A method of a second user equipment (UE), comprising:
receiving, from a first UE, sidelink control information (SCI) including a beam state information (BSI) request;
receiving, from the first UE, a beam management-reference signal (BM-RS) on a physical sidelink shared channel (PSSCH) scheduled by the SCI;
generating BSI by performing a beam measurement operation based on the BM-RS;
transmitting a BSI report including the BSI to the first UE; and
managing a reception beam of the second UE based on the BSI.

12. The method according to claim 11, wherein the BSI request triggers transmission of the BSI report, the BSI request includes resource information for transmission of the BSI report, and the BSI report is transmitted in resources indicated by the resource information included in the BSI request.

13. The method according to claim 11, wherein a BM-resource pool (RP) for a BM operation is configured independently from a sidelink-resource pool (SL-RP) for SL communication between the first UE and the second UE, and at least one of the BSI request, the BM-RS, or the BSI report is transmitted and received within the BM-RP.

14. The method according to claim 13, wherein a pair of the BM-RP and the SL-RP is configured to the second UE, and at least one of a transmission beam of the first UE or a reception beam of the second UE determined by the BM operation within the BM-RP is used for the SL communication between the first UE and the second UE within the SL-RP paired with the BM-RP.

15. The method according to claim 11, wherein the BSI request includes transmission scheme information of the BM-RS, and the transmission scheme information indicates a scheme in which the first UE transmits the BM-RS using a same transmission beam or a scheme in which the first UE transmits the BM-RS based on a beam sweeping manner.

16. The method according to claim 11, further comprising: transmitting a BM request to the first UE indicating that a BM operation is required, wherein the BM operation is triggered based on the BM request.

17. The method according to claim 11, wherein the BM request is transmitted when the BM operation is required, and cases when the BM operation is required include at least one of a case when a transmission beam of the first UE needs to be change, a case when a reception beam of the second UE needs to be changed, a case when a beam pair between the first UE and the second UE needs to be changed, or a case when a beam failure occurs between the first UE and the second UE.

18. A first user equipment (UE) comprising at least one processor, wherein the at least one processor causes the first UE to perform:
transmitting a scheduling request (SR)-beam management (BM) requesting resource allocation for a BM operation to a base station;
in response to the SR-BM, receiving a response-SR including resource allocation information from the base station; and
performing the BM operation with a second UE based on resources indicated by the resource allocation information.

19. The first UE according to claim 18, wherein in the performing of the BM operation, the at least one processor further causes the first UE to perform:
transmitting a beam state information (BSI) request to the second UE based on the resources indicated by the resource allocation information;
transmitting a BM-reference signal (RS) to the second UE based on the resources indicated by the resource allocation information;
receiving a BSI report including beam measurement information based on the BM-RS from the second UE; and
managing a transmission beam of the first UE based on the beam measurement information included in the BSI report,
wherein the BSI request triggers transmission of the BSI report.

20. The first UE according to claim 18, wherein the at least one processor further causes the first UE to perform: receiving a BM request from the second UE indicating that the BM operation is required, wherein a transmission operation of the SR-BM is triggered based on the BM request.
